(19) United States
(12) Patent Application Publication
(10) Pub. No.: US 2006/0086870 A1
(43) Pub. Date: Apr. 27, 2006

(54) Flexible figurine toilet paper roll holder

(76) Inventor: Bryan W. Nida, Boise, ID (US)

Correspondence Address: PEDERSEN & COMPANY, PLLC, P.O. BOX 2666, BOISE, ID, 83701, US

(21) Appl. No.: 10/972,021

(22) Filed: Oct. 22, 2004

(51) Int. Cl. F16M 11/00

(52) U.S. Cl. 248/176.1

(57) ABSTRACT

A toilet paper roll holder comprising a flexible figurine that stores a toilet paper roll, as well as functioning as a novelty item for decorating a bathroom or other room. The flexible figurine comprises a plurality of appendages for holding the toilet paper roll in a raised or elevated position above the surface upon which the toilet paper roll holder rests. The appendages may have projections at their extremities that resemble hands, feet, tentacles, etc. in order to make the toilet paper roll holder representative of a person, animal, or thing. Further, the toilet paper roll holder may include a head portion that is partially or completely visible over the top of the toilet paper roll. The head portion may be a hat, ears, or hair, or less preferably a face, depending on the desired representative figure.

### BACKGROUND OF THE INVENTION

1. Field of the Invention

This invention relates to toilet paper roll holders, and, more specifically, to toilet paper roll holders comprising a flexible figurine. The invention further relates to toilet paper roll holders that may be positioned to hold/store the toilet paper roll, and then, alternatively, positioned to “release” the toilet paper roll.

2. Related Art

In the past, flexible figures have been made as novelty items. For example, the Benders™ series made by Hogwild comprises posable, stand-alone magnetic figures with various accessories (www.hogwildtoys.com/benders.html). The Bender is posed with its accessory to resemble a given miniature caricature, for example, a snowboarder, farmer, sunbather, etc.

In the patent literature, one may find other flexible toy figures, such as in U.S. Pat. Nos. 280,9866, 1,590,898, 1,872,544, 2,209,791, 2,392,024, 2,601,740, 2,684,503, 3,668,805, 4,197,358, and 6,746,303.

In addition, U.S. Pat. No. 5,799,980 discloses a book with posable projections projecting outwardly from the book. U.S. Pat. No. 5,833,509 discloses a book with a three dimensional character joined to the book.

It is an object of the present invention to provide a flexible figurine that is not only a novelty, but also functions as a holder or storage device for a toilet paper roll.

### SUMMARY OF THE INVENTION

The present invention relates generally to toilet paper roll holders, and, more specifically, to toilet paper roll holders comprising a figurine for holding/storing the toilet paper roll. The invented toilet paper roll holder is adapted to function not only as a storage unit for the toilet paper roll, but also as a decorative object for display in a bathroom or other room. The figurine is preferably flexible in order to be positioned to secure the toilet paper roll in a storage position, or to release the toilet paper roll for use.

The preferred embodiment of the invented toilet paper roll holder is a figurine comprising a main body portion, and one or more appendages protruding from the main body portion. Preferably, one or more appendages protrude generally perpendicularly from the upper portion of the main body (ie. upper portion appendages), and one more or more appendages depend or extend generally parallel from the lower portion of the main body (ie. lower portion appendages). In the preferred embodiment, the main body and the appendages of the figurine are flexible in order to be adapted for either holding/securing or releasing the toilet paper roll.

When the toilet paper roll holder is in the storing or “closed” position, the upper portion appendages may partially or completely encircle the outer circumference of the toilet paper roll. The lower portion appendages preferably extend below the bottom plane of the toilet paper roll, so that the bottom plane of the toilet paper roll is raised above the surface upon with the toilet paper roll holder rests.

When the toilet paper roll holder is in the releasing or “open” position, the upper portion appendages are positioned away from the outer circumference of the toilet paper roll. The toilet paper roll is then “released” from the toilet paper roll holder for use. Alternatively, due to the flexibility of the appendages, the user may pull the toilet paper roll out from the appendages without having to first bend the appendages away from the toilet paper roll.

The preferred embodiment of the invented toilet paper roll holder may comprise a head portion that may partially or completely extend above the top plane of the toilet paper roll. The head portion is preferably connected to the main body of the figurine. The head portion preferably has no face, but comprises a hat, hair, ears, or other structure that suggests a head or face.

In an alternative embodiment, the lower portion appendages may extend from the upper portion appendages without any main body portion.

### BRIEF DESCRIPTION OF THE DRAWINGS

FIG. 1A is a front view of one embodiment of the toilet paper roll holder figurine, wherein no head portion is shown.

FIG. 1B is a left side view of the embodiment shown in FIG. 1A.

FIG. 1C is a left side view of the embodiment shown in FIGS. 1A and 1B, with the toilet paper roll installed.

FIGS. 2A-16 show a toilet paper roll installed in various embodiments of figurines, resulting in various embodiments of toilet paper roll holders.

FIG. 2A is a front view of another embodiment of the toilet paper roll holder, wherein the figurine is representative of a rabbit.

FIG. 2B is a left side view of the embodiment shown in FIG. 2A.

FIG. 2C is a front view of the figurine shown in FIGS. 2A-B, wherein the toilet paper is shown only in dashed lines.

FIG. 3A is a front view of another embodiment of the toilet paper roll holder, wherein the figurine is representative of Mickey Mouse.

FIG. 3B is a left side view of the embodiment shown in FIG. 3A.

FIG. 3C is a front view of the figurine shown in FIGS. 3A-B, wherein the toilet paper is shown only in dashed lines.

FIG. 4A is a front view of another embodiment of the toilet paper roll holder, wherein the figurine is representative of a wizard.

FIG. 4B is a left side view of the embodiment shown in FIG. 4A.

FIG. 4C is a front view of the figurine shown in FIGS. 4A-B, wherein the toilet paper is shown only in dashed lines.

FIG. 5A is a front view of another embodiment of the toilet paper roll holder, wherein the figurine is representative of a witch.

FIG. 5B is a left side view of the embodiment shown in FIG. 5A.

FIG. 5C is a front view of the figurine shown in FIGS. 5A-B, wherein the toilet paper is shown only in dashed lines.

FIG. 6A is a front view of another embodiment of the toilet paper roll holder, wherein the figurine is representative of a butler.

FIG. 6B is a left side view of the embodiment shown in FIG. 6A.

FIG. 6C is a front view of the figurine shown in FIGS. 6A-B, wherein the toilet paper is shown only in dashed lines.

FIG. 7A is a front view of another embodiment of the toilet paper roll holder, wherein the figurine is representative of Batman.

FIG. 7B is a left side view of the embodiment shown in FIG. 7A.

FIG. 7C is a front view of the figurine shown in FIGS. 7A-B, wherein the toilet paper is shown only in dashed lines.

FIG. 8A is a front view of another embodiment of the toilet paper roll holder, wherein the figurine is representative of a cowboy.

FIG. 8B is a left side view of the embodiment shown in FIG. 8A.

FIG. 8C is a front view of the figurine shown in FIGS. 8A-B, wherein the toilet paper is shown only in dashed lines.

FIG. 9A is a front view of another embodiment of the toilet paper roll holder, wherein the figurine is representative of a construction worker.

FIG. 9B is a left side view of the embodiment shown in FIG. 9A.

FIG. 9C is a front view of the figurine shown in FIGS. 9A-B, wherein the toilet paper is shown only in dashed lines.

FIG. 10 is a left side view of another embodiment of the toilet paper roll holder, wherein the figurine is representative of a wizard, and wherein the head portion extends over the top plane of the toilet paper roll.

FIG. 11 is a left side view of another embodiment of the toilet paper roll holder, wherein the figurine is representative of a witch, and wherein the head portion extends over the top plane of the toilet paper roll.

FIG. 12 is a left side view of another embodiment of the toilet paper roll holder, wherein the figurine is representative of a butler, and wherein the head portion extends over the top plane of the toilet paper roll.

FIG. 13 is a left side view of another embodiment of the toilet paper roll holder, wherein the figurine is representative of Batman, and wherein the head portion extends over the top plane of the toilet paper roll.

FIG. 14 is a left side view of another embodiment of the toilet paper roll holder, wherein the figurine is representative of a cowboy, and wherein the head portion extends over the top plane of the toilet paper roll.

FIG. 15 is a left side view of another embodiment of the toilet paper roll holder, wherein the figurine is representative of Mickey Mouse, and wherein the head portion extends over the top plane of the toilet paper roll.

FIG. 16 is a left side view of another embodiment of the toilet paper roll holder, wherein the figurine is representative of a construction worker, and wherein the head portion extends over the top plane of the toilet paper roll.

FIG. 17 is a front view of an alternative embodiment of the toilet paper roll holder, wherein the lower appendages of the toilet paper roll holder are attached to the upper appendages of the toilet paper roll holder without a main body.

### DESCRIPTION OF THE PREFERRED EMBODIMENTS

Referring to the figures, there are shown several, but not the only, embodiments of the invented flexible figurine toilet paper roll holder.

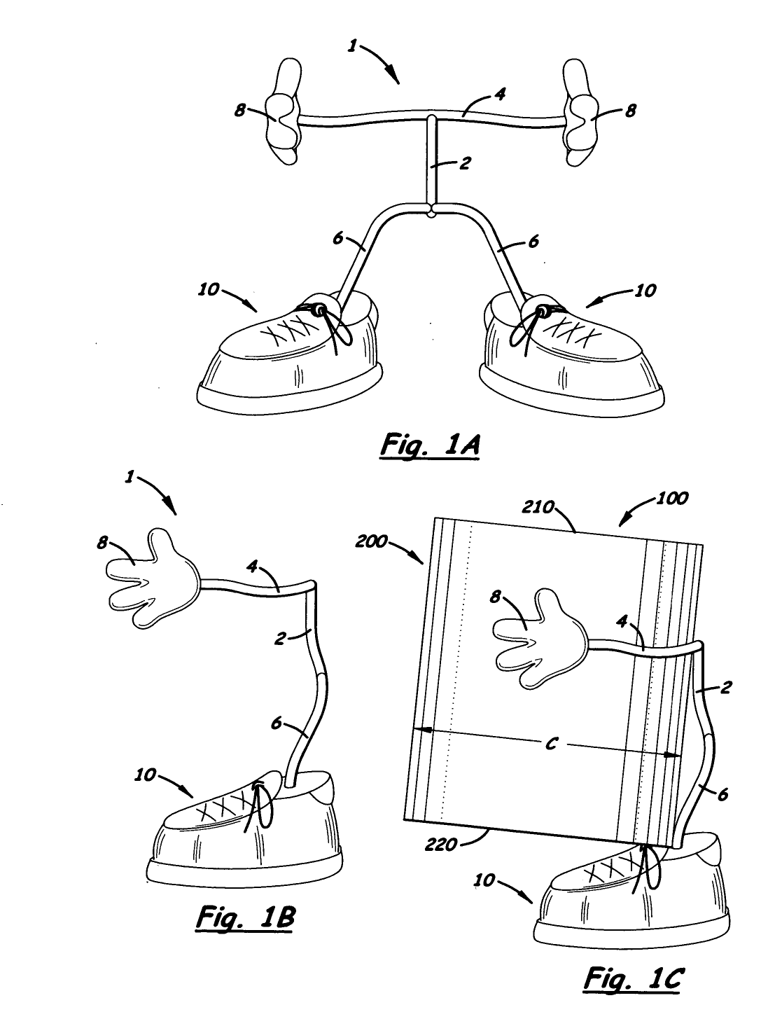

Referring specifically to FIGS. 1A-C, one embodiment of the invented toilet paper roll holder 100 comprises a flexible figurine 1 combined with a toilet paper roll 200. The figurine 1 is preferably adapted to releasably hold the roll 200 by gripping and supporting the outer surface of the toilet paper roll 200, rather than by extending through or attaching to the toilet paper roll's tube. Preferably, the toilet paper roll holder 100 does not dispense toilet paper from the roll 200, but merely stores and displays the toilet paper roll 200, for example, as the extra replacement roll needed in a bathroom. The preferred figurine is not fixed to the paper roll, so that the paper roll is easily removable without modifying the paper roll or the figurine except for bending or otherwise releasing the appendages of the figurine from the roll. The preferred figurine is not integral with the paper roll, that is, it is not manufactured with the roll as a single unit.

Preferably, the flexible figurine 1 comprises a main body portion 2, one or more upper appendages 4, and one or more lower appendages 6. As shown in FIGS. 1A and 1B, the upper appendages 4 preferably extend perpendicularly from the main body portion 2. The upper appendages 4 may comprise a hand portion 8 at their extremities. The same hand shape is shown in FIGS. 1-17, however, alternative hand shapes may be used as desired to more closely match the representative figure, such as gloves, paws, wings, tentacles, etc. The hand portions 8 may be separably bendable relative to the upper appendages 4, and, in a less preferred embodiment, the hand portions 8 may be removable relative to the upper appendages 4.

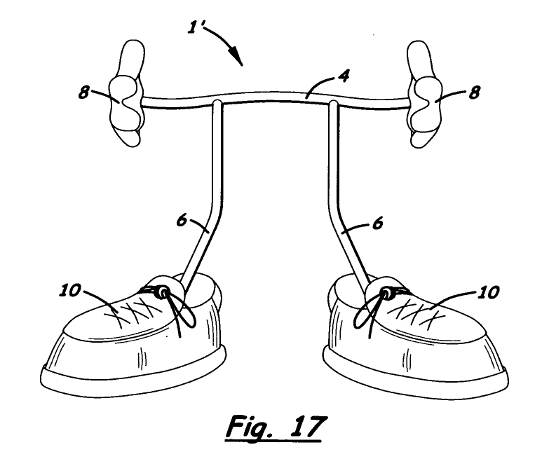

The lower appendages 6, preferably extend from the main body portion 2 generally parallel to each other and to the main body portion 2 (see FIGS. 1A-C). The lower appendages 6 may comprise a foot portion 10 at their extremities that is representative of the figurine, such as rabbit feet 20, Mickey Mouse feet 30, wizard shoes 40, witch shoes 50, butler shoes, 60, Batman shoes 70, cowboy shoes 80, and construction shoes 90 (see FIGS. 1A-17). Herein after, only call-out 10 is used to refer to the foot portions in order to simplify the description. Alternative foot portions 10, other than those shown in FIGS. 1A-17, may be used to more closely match the representative figurine. In an alternative embodiment of the figurine 1′, the lower appendages 6 may be attached to the upper appendages 4, without any main body 2 (see FIG. 17). Further, the foot portions 10 may be separably bendable relative to the upper appendages 6, and in a less preferred embodiment, the foot portions 10 may be removable relative to the lower appendages 6.

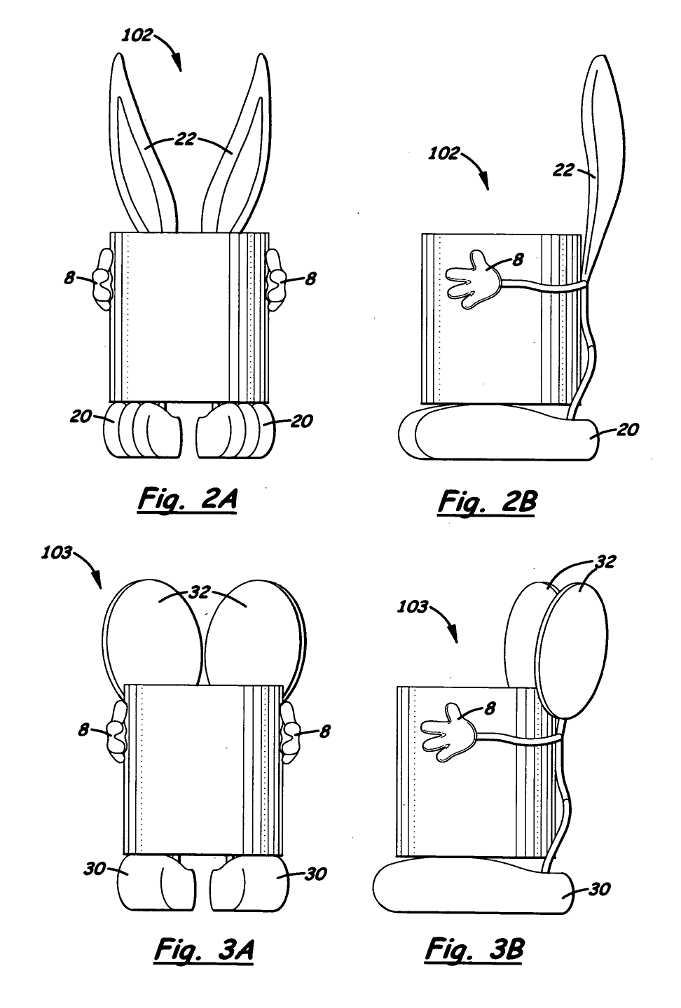

As shown in FIGS. 1A-C, the foot portions 10 may be smaller than the diameter of the bottom plane of the toilet paper roll 200. This may be desirable because the foot portions 10 would be in better proportion with the hand and head portions. The smaller foot portions 10 offer an interesting appearance by reducing the amount of the figurine 1 exposed, so that the user must use more of their imagination to determine what caricature the toilet paper roll holder represents. For example, as suggested by FIG. 1C, a person viewing toilet paper roll holder 100 from the front would probably only see the toilet paper roll 200, part or all of the hand portions 8, and a small amount or none of the foot portions 10. When viewed from the front, only the toe or tip of the shoe of the foot portions 10 is exposed. Alternatively, the foot portions 10 may be larger in size, so that they extend nearly or completely across or beyond the diameter of the bottom plane 220 of the toilet paper roll 200 (see FIGS. 2A-17). This may be desirable to aid in balancing and stabilizing the toilet paper roll holder 100 on the table or other horizontal surface. Therefore, in the preferred embodiment, the foot portions 10 may preferably extend, for example, from ¼ of the way to all the way (25%-100%) across the diameter of the bottom plane 220 of the toilet paper roll 200.

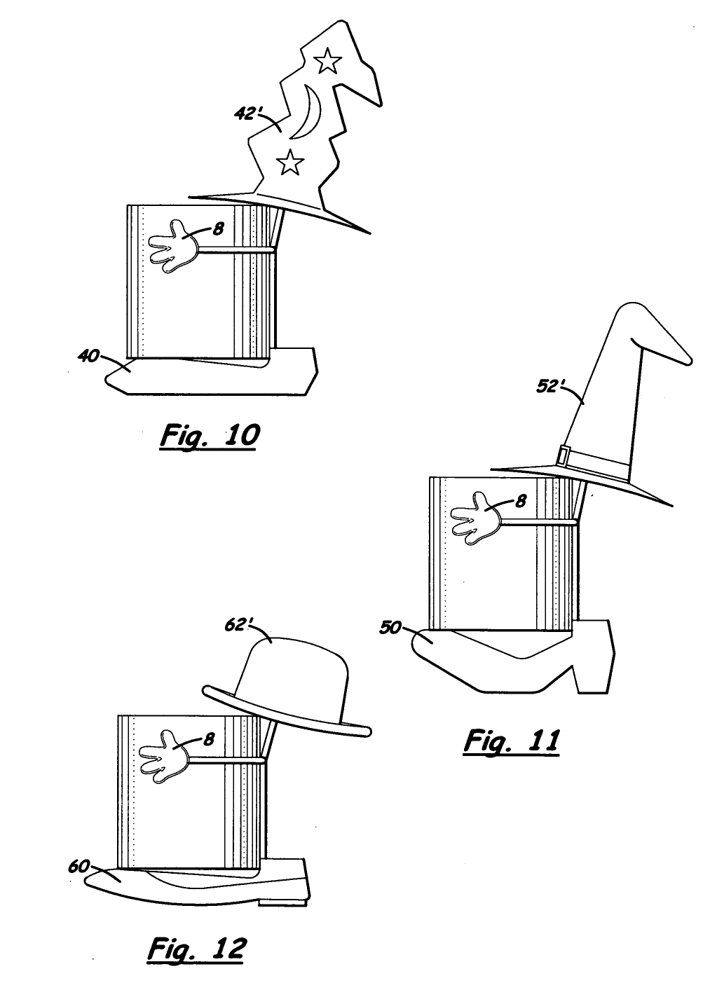

In addition to the upper appendages 4 and the lower appendages 6, the figurine 1 may comprise a head portion, as illustrated by the toilet paper roll holders (102, 103, 104, 105, 106, 107, 108, and 109), in FIGS. 2-9. Additionally, FIGS. 2-9 illustrate the following head portions: rabbit ears 22, Mickey Mouse ears 32, a wizard hat 42, a witch's hat 52, a butler hat 62, Batman's hat 72, a cowboy hat 82, and a construction hat or “hard hat” 92. However, the inventor envisions that other head portions may be selected depending on the desired representative figurine. As shown in FIGS. 2A, 3A, 4A, 5A, 6A, 7A, 8A, and 9A, the head portion is preferably only partially visible over the top plane 210 of the toilet paper roll 200 when viewing the front of the toilet paper roll holder, so that there is only the mere suggestion of a full “head” and a full ‘body’. In the preferred embodiment, the head portion is only slightly greater than two dimensional (see FIGS. 2B, 3B, 4B, 5B, 6B, 7B, 8B, and 9B), so the head portion may reside behind the toilet paper roll. Preferably the head portion is only a 0.25 inch to 0.5 inch in thickness, and only one-quarter to ⅞ (more preferably only one-quarter to three-quarters) of the head portion is visible when the toilet paper roll holder is viewed from the front (see FIGS. 2A, 2C, 3A, 3C, 4A, 4C, 5A, 5C, 6A, 6C, 7A, 7C, 8A, 8C, 9A, 9C). In alternative embodiments, the head portion may be three dimensional so that the head portion (32′, 42′, 52′, 62′, 72′, 82′, and 92′) extends over the top plane 210 of the toilet paper roll 200, as shown in FIGS. 10-16.

When the toilet paper roll holder is in the storing/operable or “closed” position, the upper appendages 4 may partially or completely encircle the circumference C of the toilet paper roll 200. Preferably, the upper appendages 4 encircle the circumference C greater than 180 degrees, and most preferably in the range of 181 to 225 degrees. The upper appendages 4 are bent into position, so that they tightly “grip” the toilet paper roll 200 to the extent that the toilet paper roll 200 will not accidentally slip or fall out of the toilet paper roll holder. In the “closed” position, the foot portions 10 of the lower appendages 6 are positioned below the bottom plane 220 of the toilet paper roll 200, so that the toilet paper roll holder is in a generally upright position on the foot portions 10, which in turn rest upon a surface, such as a table, counter-top, toilet tank, or other horizontal surface. Preferably, no part of the figurine, and no part of the holder, extends into or touches the axial tube of the paper roll (the tube on which the paper is wound). Preferably, the paper roll is held generally vertically, with the axial tube generally vertical, so that the side surface of the paper is substantially all that is seen in a front view of the toilet paper roll holder.

The lower appendages 6 may be purposefully bent to the most advantageous position for maintaining the stability of the toilet paper roll holder. The foot portions 10 may be weighted to help balance the figurine 1 and the toilet paper roll 200. While in the “closed” position, the toilet paper roll 200 may rest upon the foot portions 10 so that the top and bottom planes, 210 and 220 respectively, are generally parallel to the surface upon which the toilet paper roll holder 100 is resting, or said top 210 and bottom 220 planes may be oriented at an angle between 0 and 90 degrees, but preferably between 0 and 45 degrees, from the surface upon which the toilet paper roll holder is resting. Alternatively, the upper appendages 4 may engage or “grasp” the paper roll firmly and securely enough so that they support the paper roll above the top surface of, and/or not touching, the foot portions.

When the toilet paper roll holder 100 is in the releasing or “opened” position, the user bends the upper appendages 4 away from the toilet paper roll 200 a sufficient distance, so as to remove the toilet paper roll 200 without tearing any of the toilet paper. The upper appendages 4 will preferably remain in this “open arm” position until they are rebent to hold another toilet paper roll. When the toilet paper roll holder 100 is in the “open arm” position, the toilet paper roll holder serves as a reminder to the user to replace the spare toilet paper roll 200 in the figurine 1. Further, when the toilet paper roll holder 100 is in the “open arm” may be possible to view optional indicia (not shown) printed or otherwise attached to the figurine, such as, advertisements, company names, personal names, etc.

In the preferred embodiment, the figurine is preferably flexible, so that the appendages, 4 and 6, may be manipulated or bent to selectively hold the toilet paper roll in a desired position until the user rebends them. The flexible figurine may be made of bendable wire that may be reinforced with a pliable rubber material, such as polyurethane. Other elastomeric materials, not just covered wire, and other methods for constructing the invented figurine will be known to those skilled in the art. By bendable, it is meant that the figurine is able to be turned or forced from straight or even to curved or angular, or forced back to an original straight or even condition. The bendable wire may extend from the appendages into the hand and foot portions, 8 and 10 respectively, so that the hand and foot portions are bendable relative to the appendages, and, the wire may be further extended into the ‘fingers’ or ‘toes’, so that the individual ‘fingers’ and ‘toes’ are separably bendable relative to the hand and foot portions.

Preferably, the figurine is made of a material having a sufficient resiliency as to support the weight of the toilet paper roll and remain in the selected position until the appendages are rebent. In a less preferred embodiment, the appendages only flex out of the way when the user removes the toilet paper roll, but their resiliency brings them immediately back to their original position. In other words, the paper roll may be “snapped in and out” of the appendages, however, this embodiment is less preferable because the appendages could tear the toilet paper roll as the user tries to remove the roll.

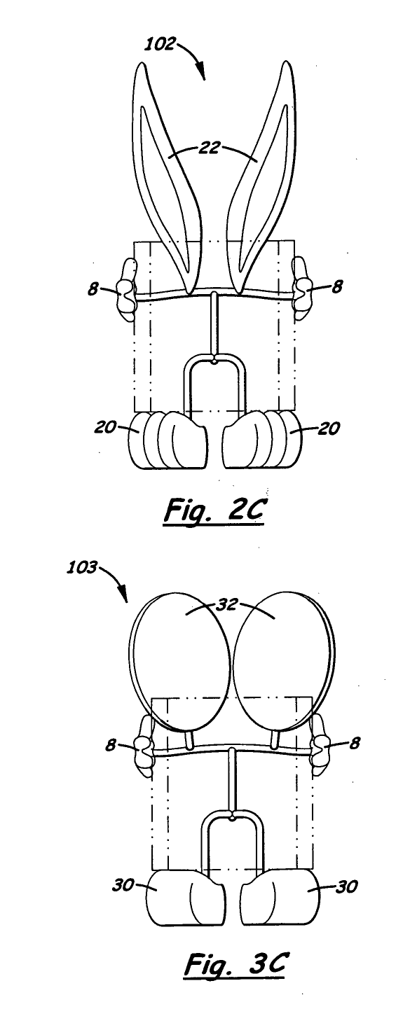

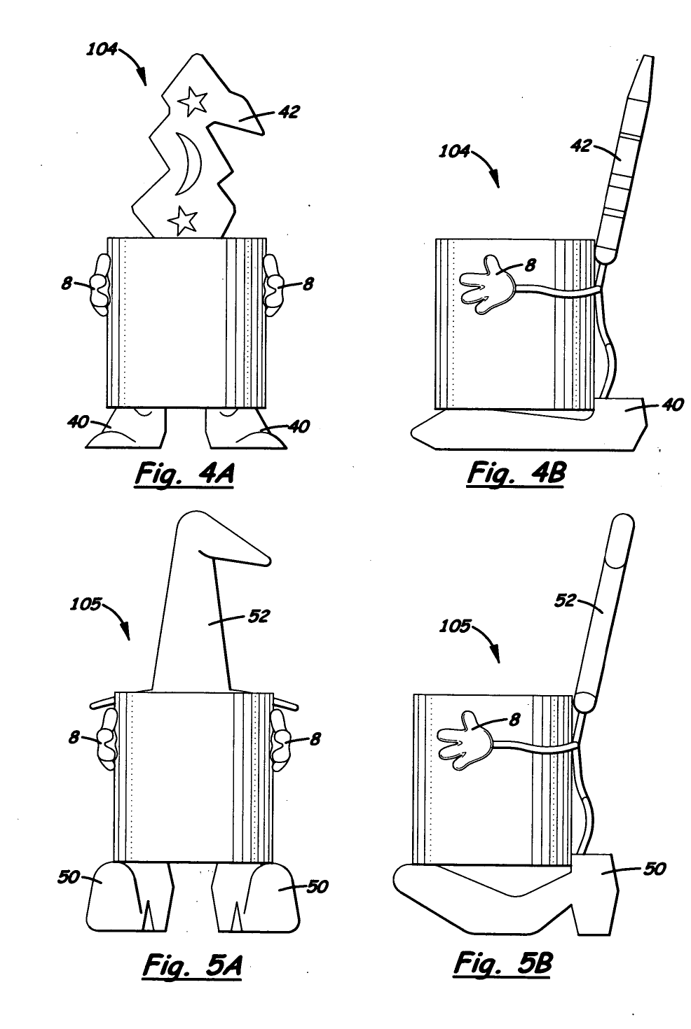

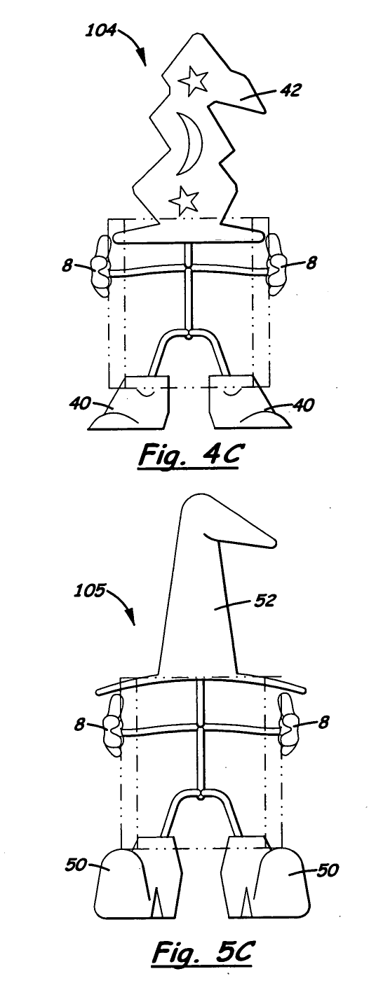

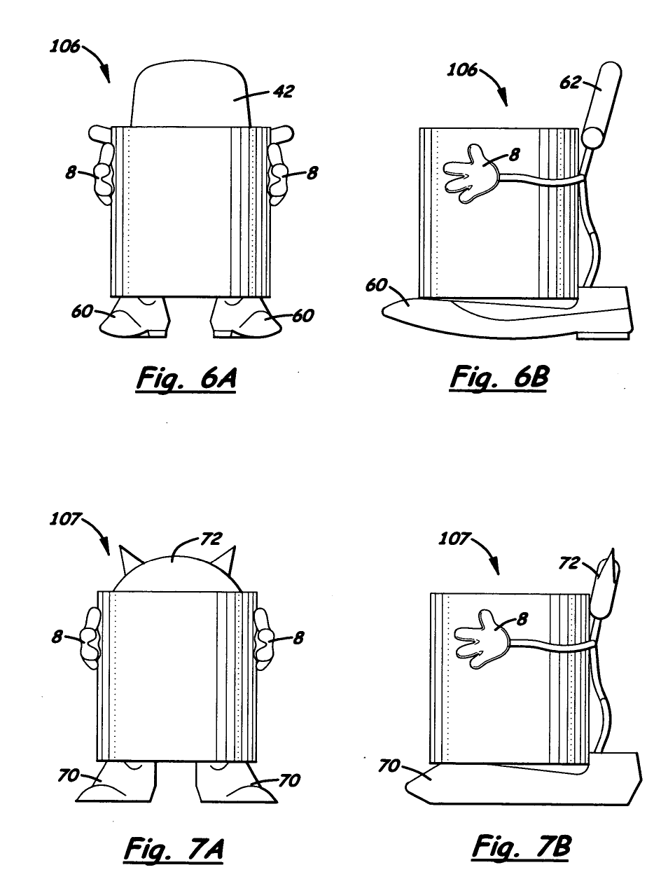

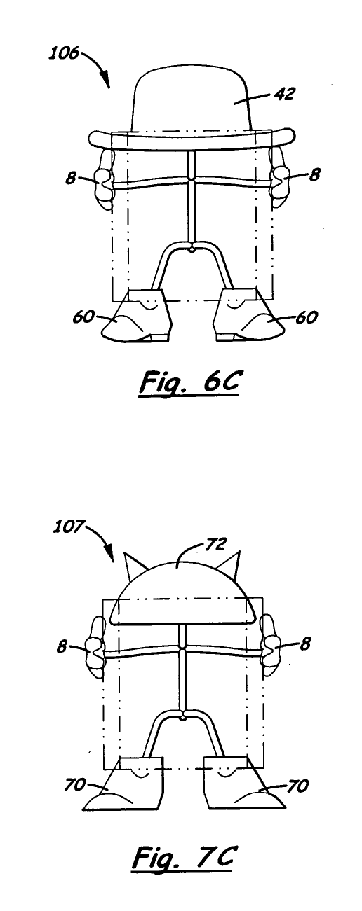

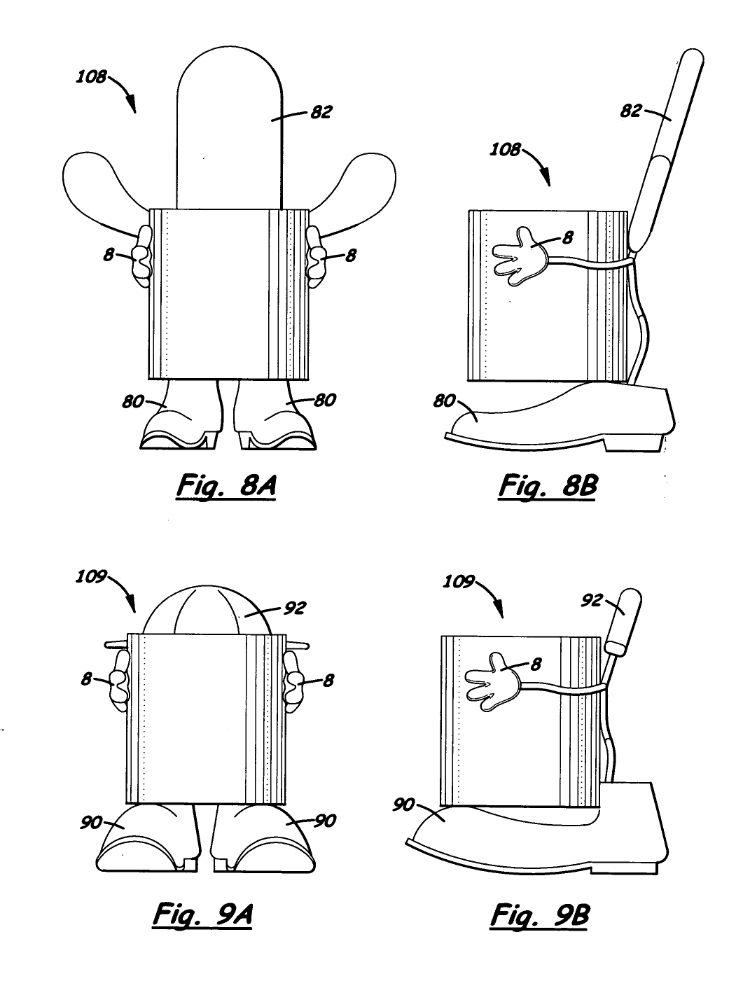

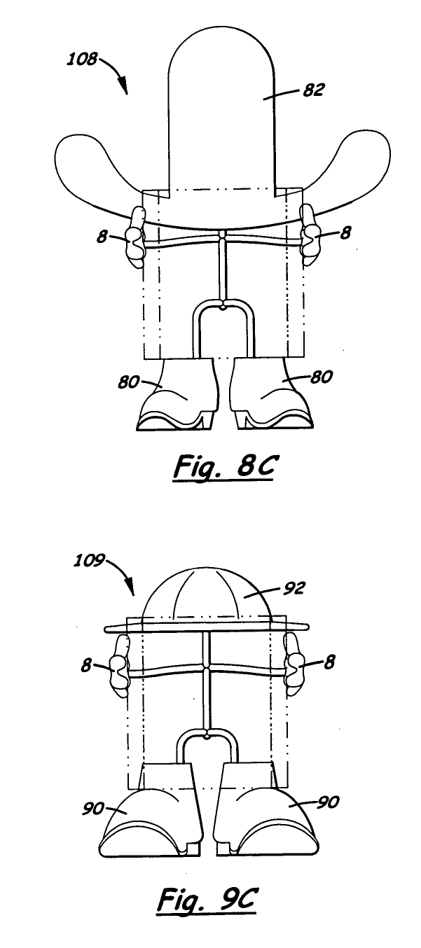

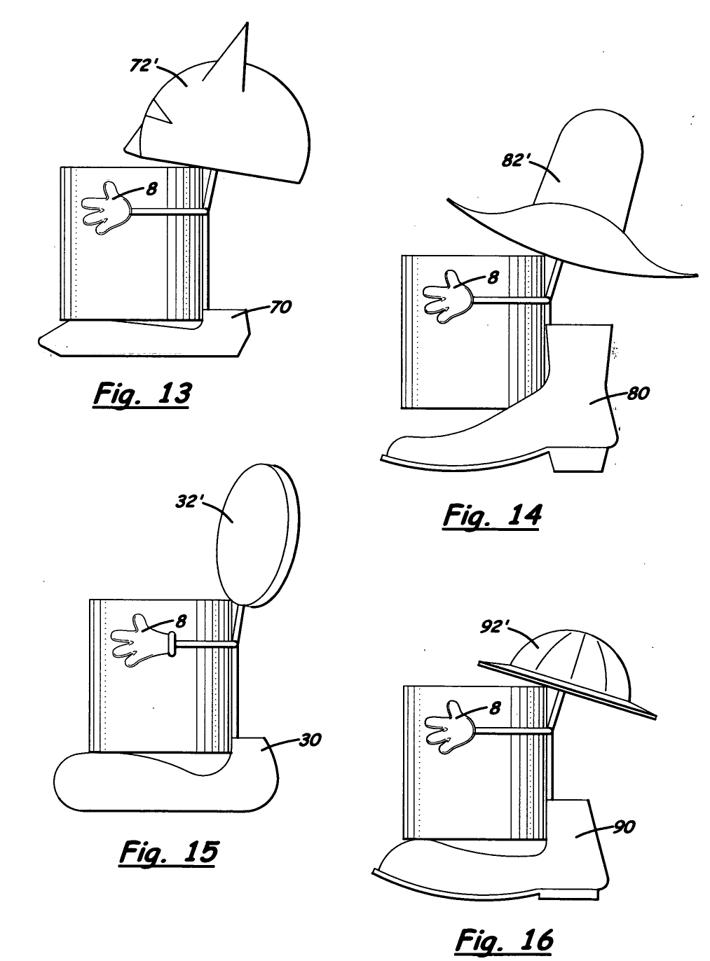

In the figures, the inventor has selected a sampling of figurines: FIGS. 1A and 1B are representative of a figurine without a head portion and with tennis shoes 10; FIGS. 2A-2C are representative of a rabbit; FIGS. 3A-3C, and 15 are representative of Mickey Mouse; FIGS. 4A-4C, and 10 are representative of a wizard; FIGS. 5A-5C, and 11 are representative of a witch; FIGS. 6A-6C, and 12 are representative of a butler; FIGS. 7A-7C, and 13 are representative of Batman; FIGS. 8A-8C, and 14 are representative of a cowboy; and FIGS. 9A-9C, and 16 are representative of a construction worker. The inventor envisions that other figurines comprising a head portion and a plurality of appendages may be used, such as other animals, people, cartoons, etc. Additionally, other size paper rolls may be used, such as paper towel rolls.

The figures illustrate embodiments comprising a head portion made substantially of ears or a hat, as it is preferred to have a simple “suggestion” of the character. It is also preferred that the figurine not have a full body shape, such as a well-defined torso, arms, legs, or clothes, but rather only flexible wire hinting at a body structure. Alternative head portions may include, for example: ears plus a hat, hair or fur alone, hair or fur with a hat and/or ears, a nose, one or more eyes, one or more antennae or less preferably, a general head shape (ie. a simple disk or wire shape) with or without ears, hair, fur, glasses, or a hat, a face, and combinations thereof.

Although this invention has been described above with reference to particular means, materials and embodiments, it is to be understood that the invention is not limited to these disclosed particulars, but extends instead to all equivalents within the scope of the following claims.

I claim:

1. A paper roll holder comprising:
a figurine comprising at least one flexible portion; and
a paper roll held by said figurine;
wherein said flexible portion contacts an outer surface of the paper roll.

2. A paper roll holder as in claim 1, wherein said figurine comprises a main body and a first plurality of flexible appendages extending generally perpendicularly from the main body, wherein said first plurality of flexible appendages contact the outer surface of the paper roll.

3. A paper roll holder as in claim 2, wherein said first plurality of appendages bend circumferentially around the paper roll to grip the paper roll.

4. A paper roll holder as in claim 1, wherein said figurine comprises a main body and a second plurality of flexible appendages extending generally parallel to the main body.

5. A paper roll holder as in claim 4, wherein said second plurality of flexible appendages comprise one or more foot portions adapted for placement on a horizontal surface so that the paper roll is held above said horizontal surface.

6. A paper roll holder as in claim 5, wherein said figurine holds said paper roll only by said flexible portion releasably contacting said outer surface of the paper roll and by said paper roll removably resting on said one or more foot portions.

7. A paper roll holder as in claim 1, further comprising a head portion having an upper portion extending above the paper roll.

8. A paper roll holder as in claim 7, wherein said head portion comprises a member selected from the group consisting of: a hat, ears, hair, fur, a nose, one or more eyes, one or more antennae, a face, and combinations thereof.

9. A paper roll holder as in claim 1, further comprising a head portion comprising a member selected from the group consisting of: a hat, ears, hair, fur, a nose, one or more eyes, one or more antennae, a face, and combinations thereof, wherein only ¼-¾ of said member is visible above the paper roll.

10. A paper roll holder as in claim 7, wherein said paper roll comprises an axial tube and paper wound on the axial tube, and wherein said paper roll has a diameter transverse to the axial tube, wherein said paper roll is oriented in the figurine so that the axial tube is generally vertical, and wherein said upper portion of the head portion further extends across a top plane of the paper roll across 25-100% of the diameter.

11. A paper roll holder as in claim 1, wherein said flexible portion is bendable to release the paper roll from the figurine.

12. A paper roll holder as in claim 1, wherein said figurine is not fixed to and is not integral with the paper roll.

13. A paper roll holder as in claim 1, wherein said paper roll is selected from a group consisting of a toilet paper roll and a paper towel roll.

14. A paper roll holder as in claim 1, wherein said paper roll comprises an axial tube and paper wound on the axial tube, and wherein none of the figurine contacts said axial tube and none of the figurine extends into said axial tube.

15. A paper roll holder comprising:
a figurine having a plurality of appendages; and
a paper roll held by said figurine;
wherein at least one of said plurality of appendages flexibly extends around a portion of said paper roll.

16. The paper roll holder as in claim 15, wherein said plurality of appendages are selected from a group consisting of arms, paws, wings, and tentacles.

17. The paper roll holder as in claim 15, wherein the figurine comprises a head portion comprising a member selected from a group consisting of rabbit ears, mouse ears, a wizard hat, a witch hat, a butler hat, a cowboy hat, and a hard hat.

18. A paper roll holder comprising a figure and a paper roll, wherein the figure comprises a foot portion adapted for placement on a horizontal surface and comprises a plurality of flexible appendages extending at least partially around a circumference of the paper roll and holding the paper roll above the horizontal surface, wherein the paper roll is removable from the figure when the flexible appendages are flexed away from the paper roll.

19. The paper roll holder as in claim 18, wherein, when the flexible appendages hold the paper roll above the horizontal surface, the paper roll is above a top surface of the foot portion.

20. The paper roll holder as in claim 18, wherein, when the flexible appendages hold the paper roll above the horizontal surface, the paper roll rests on a top surface of the foot portion.
